(19) United States
(12) Patent Application Publication
(10) Pub. No.: US 2011/0040638 A1
(43) Pub. Date: Feb. 17, 2011

(54) GAMING INTERFACE TO ONLINE AUCTION

(76) Inventors: Nancy J. Rabenold, Brandon, FL (US); James A. Simmons, Brandon, FL (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/541,774

(22) Filed: Aug. 14, 2009

(51) Int. Cl. G06Q 30/00

(52) U.S. Cl. 705/14.73; 705/26.3

(57) ABSTRACT

An integration of an online auctioning system with the user interface look and feel of a desired application can be performed at varying levels. At one level, a simple mapping of characteristics and actions in the auctioning environment are mapped to characters, actions, features, etc. of the user interface. At another level, the bidder participates in a live auction in a manner that is akin to playing or operating the user interface of the desired application. At yet another level, the user interface and the desire application do not interface to a live auction at all, but rather, define a new game or application that is auction based.

### CROSS-REFERENCE TO RELATED PATENTS

This application is related to a United States patent application that has a title of VIRTUAL WORLD INTEGRATED AUCTION, identified by Attorney Docket Number 01004.1110, which was filed concurrently with this application, and U.S. Pat. No. 6,813,612, both of which are hereby incorporated by reference in their entirety.

### BACKGROUND

The electronic gaming industry, quickly capitalizing on the advances in video technology such as high-definition and highly-intensive graphics, continues to infiltrate and dominate the time of younger generations. Users can spend countless hours in front of their favorite games, such as HALO3, THE ORANGE BOX, ROCK BAND, SUPER MARIO GALAXY, BIO SHOCK, CALL OF DUTY 4, LEGEND OF ZELDA, MASS EFFECT, ACE COMBAT 6 and GOD OF WAR 2, striving to reach a next level, attain a highest score, or simply to be the best or better. The fondness of which these “gamers” have for these games has been exploited by marketing companies in a wide variety of ways. The characters and “look-and-feel” action make their way onto T-shirts, lunch boxes, candy, posters, tattoos, games, toys and a wide variety of other merchandise. Such marketing is successful because, similar to people who wear collegiate branded clothes, the gamers find an identity within their gaming environment.

Other industries tend to capitalize on the vernacular of the day when trying to reach a particular market segment. The present day gaming market segment has been widely referred to as generation Y, or Gen-Y. To reach Gen-Y, marketers realize that they must speak the Gen-Y language, which for a large segment of that population is the gaming environment. Thus, having the ability to tweak or augment any product to be affiliated with one of the popular gaming environments is going to have an increased appeal to those gamers that identify with the selected gaming environment. Even more benefit would be realized if a product could be adapted or modified by user selection to be affiliated with multiple gaming environments or to switch between gaming environments.

Auction Management Solutions out of Tampa Fla. is the industry leader in the development and deployment of on-line auctioning, including the integration of online and live, at the auction bidders for participation in a single, real time auction event. The technology available from Auction Management Solutions is marketed under the name of ONLINE RINGMAN. Information about the ONLINE RINGMAN product is provided in the text of U.S. Pat. No. 6,813,612 which is incorporated herein by reference or at AMS' website viewable at the URL of www.auctionsolutions.com.

The ONLINE RINGMAN product is used in a wide variety of settings by multiple companies. However, in order to capture a large audience, it would be beneficial for the user interface to the ONLINE RINGMAN system to be affiliated with one or more of the popular Gen-Y gaming environments.

### BRIEF SUMMARY

In general, embodiments provide an integration of an online auctioning system with a user interface having a look and feel of a desired application at varying levels. At one level, a simple mapping of characteristics and actions in the auctioning environment are mapped to characters, actions, features, etc. of the user interface. At another level, the bidder participates in a live auction in a manner that is akin to playing or operating the user interface of the desired application. At yet another level, the user interface and the desire application do not interface to a live auction at all but, rather, define a new game or application that is auction based.

More specifically, one embodiment includes a computing platform that integrates an online auctioning system with the user interface associated with a desired application. The computing platform includes a processor, a memory device communicatively coupled to the processor and containing definitions for the user interface associated with the desired application and characteristics of the online auctioning system, a third party interface to a real-world live auction for receiving auction data, a user interface and a blending component. The blending component resides on a memory device and includes instructions that, when executed by the processor, cause certain functions to be performed. Initially, the blender identifies elements associated with the user interface of the desired application and then identifies characteristics of the online auctioning system. The blender subsequently maps the elements of the user interface to the characteristics of the online auctioning system, generates an integrated user interface and presents it to a user. Once integrated, the blender receives actions from the user and the online auctioning system and controls the user interface based on the received actions. These and other embodiments will be more fully appreciated in the detailed description and the following figures.

### BRIEF DESCRIPTION OF THE SEVERAL VIEWS OF THE DRAWING

FIG. 1 is a block diagram illustrating an exemplary environment in which various embodiments of the online auction system and desired user interface may be integrated.

FIG. 2 is a general block diagram illustrating a hardware/system environment suitable for various embodiments of the present invention.

FIG. 3 is a flow diagram illustrating the steps in an exemplary embodiment of a virtual auction that is integrated with a real, live auction and embedded in a game space.

### DETAILED DESCRIPTION OF EMBODIMENTS

The present invention, as well as features and aspects thereof, is directed towards providing an online auctioning system that can be easily adapted, augmented, modified or affiliated with a popular user interface, such as the look-and-feel of a popular video game. In general, the functions and actions available in the user interface of an online auctioning system, such as ONLINE RINGMAN, can be represented in a definite domain that completely defines the user actions, responses, and interaction with the system. Once this is accomplished, a desired user interface can be analyzed to identify various features, aspects, actions, characters, etc., that can be mapped to the domain of available function and actions for the online auction system. The user interface elements can then be mapped on a one to one or many to one basis with the domain of available function and actions for the online auction system.

Once the user interface characters or elements are identified, the level of integration of the auctioning environment and the target environment or desired environment is defined. In one embodiment, this may be implemented as a flat integration. The flat integration environment simply means that the level of integration is limited to the mapping of the domain of available function and actions for the online auction system with the various features, aspects, actions, characters, etc. of the desired user interface.

As a non-limiting example, the integration of the ONLINE RINGMAN system and the popular ROCK BAND video game is presented. It should be appreciated that although the particular embodiment describes characteristics existing only in the ONLINE RINGMAN product, that other embodiments may be based on other online auctioning environments. In addition, the particular mappings or integration presented with regards to the ROCK BAND video game is also presented as an example and, in fact, other embodiments may rely on other features or characteristics of both the ONLINE RINGMAN system and the ROCK BAND video game. In addition, it will be appreciated that embodiments can be implemented for various levels of integration with various user interfaces and portions of these user interfaces.

ROCK BAND players use peripherals modeled after musical instruments to simulate the performance of rock music. Players must play these instruments in time with musical “notes” as they scroll towards them on the screen. ROCK BAND offers gameplay for drums and vocals, in addition to lead and bass guitars.

ROCK BAND's gameplay and on-screen interface uses a combination of elements from two other popular games: GUITAR HERO and KARAOKE REVOLUTION. ROCK BAND has up to three tracks of vertically scrolling colored music notes, one section each for lead guitar, drums, and bass. The colored notes on-screen correspond to buttons on the guitar and drum peripherals. Along the top of the screen is the vocals display, which scrolls horizontally, similar to KARAOKE REVOLUTION. The lyrics display beneath green bars, which represent the pitch of the individual vocal elements. The remainder of the screen is used to display the band's virtual characters as they perform in concert.

During cooperative play as a band, all players earn points towards a common score, though score multipliers and “Overdrive” are tracked separately for each player. Overdrive is collected during select portions of a song by successfully playing all white notes within that section (or by using the guitar controller's whammy bar during white sustained notes). Once the Energy Meter is filled halfway, players can deploy their Overdrive, resulting in the “Band Meter” (which tracks how well each player is doing) changing more dramatically. This allows players to strategically use Overdrive to raise the Band Meter and pass portions of a song they otherwise might have failed. Overdrive can be used to activate score multipliers, which vary based on a player's note streak. Players can deploy Overdrive independently of each other, as well as collect additional Overdrive while it is deployed and draining.

Each band member can choose the difficulty at which they play (spanning Easy, Medium, Hard, and Expert). If a player does not play well enough and falls to the bottom of the Band Meter, they will fail out of the song and their instrument will be muted from the audio mix. However, any active player can activate their Overdrive to bring failed players back into the song, “saving” the band member. However, a band member can only be saved twice; after the third failure, they cannot be brought back for that song. Failed players continuously drag the band's Band Meter down until they are saved. If the player is not saved before the Band Meter reaches the bottom, the band fails the song. Players can earn Overdrive bonuses from “Unison Phrases” and extra points from a “Big Rock Ending.”

In some versions, users can create and customize their own in-game character, complete with adjustable hair, body physique, clothing, tattoos, onstage movements, and instruments. Each character is permanently locked into a specific instrument. Using cash earned within the game, the player may purchase items at the in-game “Rock Shop,” with which they can customize their rock star. The game features an art maker where players can combine different clip art elements to create custom face paint, tattoos, clothing designs, instrument artwork, and band logos.

The game features special ROCK BAND-branded guitar controllers modeled after the Fender Stratocaster to be used for the lead and bass guitar gameplay. These are similar to the GUITAR HERO controllers; the colored fret buttons corresponding to on-screen notes must be held while the strum bar is pressed. The Stratocaster controller has five additional fret buttons of smaller size located on the guitar neck, closer to the guitar's main body. These buttons can be used to play all notes in guitar solos (denoted by the note track turning blue) as hammer-ons and pull-offs, without strumming. Additionally, the controller features an effects pickup switch that can toggle between five different effects, which are applied in solos and when Overdrive is activated. Overdrive for guitarists can be deployed by holding the controller in a vertical position or pressing the “Select/Back” button. The controller is offered in both wired and wireless versions.

The drum controller features four rubber drum pads and a kick pedal. The pads have colored rings around the edges that correspond to the notes on-screen, representing the snare drum (red), tom-tom (blue), hi-hat (yellow), and crash cymbal (green). The kick pedal simulates the bass drum, with on-screen notes represented as orange horizontal lines. To use the drum controller, players must strike the pads with the included authentic drum sticks and/or press the kick pedal in time with the scrolling notes on-screen. Drummers can improvise in special “freestyle drum fill” sections of songs, indicated by the columns for each note turning a solid color. Overdrive for drummers can be deployed by hitting the crash cymbal (green note for right-handed configuration) that appears directly after a freestyle drum fill.

Rock Band's USB microphone instrument is similar to the model used in the Harmonix-developed KARAOKE REVOLUTION games. For the most part, singers are judged on how closely they match the pitch of the song's vocalist. During “talking parts” that do not judge pitch, a phoneme detector will pick up individual vowels and consonants of the spoken lyrics. Some sections without vocals will display circle notes, allowing for the microphone to be used as a tambourine and cowbell by tapping it or making vocal cues. Overdrive for singers can be deployed by singing in freestyle vocal sections of songs, denoted by yellow artwork in the background of the vocals interface.

“Band World Tour” is the game's primary multiplayer mode. It allows any combination of 2-4 local players to create a virtual band, play gigs, and tour a virtual representation of the world. Although online play is not supported for Band World Tour, players can use the “Band Quickplay” mode to play together as a band online. In some versions of the game, Band World Tour mode lets bands play in 41 different venues spanning 17 cities, including Los Angeles, Seattle, Boston, New York, London, Sydney, Stockholm, and Rome. After creating their band, characters, and logo, the players can begin playing concerts in small venues in their virtual hometown until they unlock vans, tour buses and private jets, which, in turn, unlock other cities and continents. Successful performances also earn the band fans, stars, and in-game cash. Most cities and larger venues require the band to achieve a certain number of fans and stars before they are unlocked. In-game venues are inspired by real-life venues and often display local art styles from each of the represented cities.

In some versions, rather than complete predetermined lists of songs (like in previous GUITAR HERO games), players complete unique sets of activities at each venue. Performances consist of single songs, multiple song sets, “make your own” setlists, and mystery setlists. Players are also faced with decisions that are referred to as “risk-versus-reward.” For certain performances, bands are faced with an optional challenge that requires the band to average a certain amount of stars for their gig in order to reap the rewards. Bands can also choose to perform a benefit concert (earning no in-game money but gaining more fans) or “sell-out” (earning more in-game money but losing fans). Additionally, for certain gigs, bands can compete for band personnel, as well as a recording deal with a record label. The “Endless Setlist” provides players with all-day concert experience, as the setlist requires playing the entire game disc's setlist from start to finish.

Some versions of ROCK BAND contain a more stripped-down version of the Band World Tour mode, as 2-4 local players will only be able to play by completing predetermined tiers of songs ordered by difficulty. Players cannot create their own characters, nor can they choose a city, venue, or a setlist to play.

“Solo Tour” is a single-player mode offered for the lead guitar, drum, and microphone peripherals (there is no support for bass). Rather than feature the open-ended gameplay and features of the next-generation versions of Band World Tour mode, Solo Tour is structured much in the same vein as the career mode in GUITAR HERO games. Players choose/create their character and complete predetermined sets of songs ordered by difficulty, with each instrument's setlist ordered differently. By completing these sets of songs, additional songs are unlocked for play across all game modes. In these versions, players can use money earned for each performance to purchase merchandise at the “Rock Shop.” The character's cash carries over into Band World Tour mode, and vice versa.

Players can quickly play any song on any instrument individually in “Solo Quickplay.” For a competitive experience, players can individually compete against each other for each instrument type in the “Tug of War” (much like GUITAR HERO's “Face-off,” in which players trade playing sections of a song to move a meter in their favor) and “Score Duel” (much like GUITAR HERO II's “Pro Face-off,” in which each player plays the song in its entirety on the same difficulty level to earn points). These head-to-head modes are available both online and locally. “Band Quickplay” mode allows bands to quickly play any song; some versions allow any combination of 2-4 local or online players to play as a band, while other versions only support 2-4 local players. Also included in ROCK BAND is a “Tutorial Mode,” which allows players to learn how to play each instrument, and “Practice Mode,” which allows players to practice songs for each instrument.

In a flat integration of the ROCK BAND interface with ONLINE RINGMAN, the following exemplary mapping can be used:

The remote bidder is represented as playing a musical instrument, such as the guitar.

The auctioning events are depicted as the colored notes appearing on the screen.

If a user wants to enter a bid, he can press one of the colored buttons associated with the action of placing a bid at the next bidding increment.

If a user wants to enter a bid at a higher amount, the user can press a different colored button followed by a sequence of buttons that either define a particular bid amount or a particular bid increase.

If the user's bid is accepted and he or she becomes the highest bidder, the user may be allowed to enter a freestyle mode that reverts to the standard GUITAR HERO play action until another bidder outbids the user.

The user can then resume participation in the auction as previously described.

In the afore described embodiment, the user thus actually interfaces with and actively participates in a live auction using the ROCK BAND interface.

In another embodiment, the ONLINE RINGMAN system or real-world auction system may not be employed. For instance, rather than participating in a live auction, the ROCK BAND interface or ROCK BAND-like interface may simply be a game interface for an auctioning style game. This embodiment may allow the user to operate in one of at least two modes: as a bidder or as an auctioneer. In some embodiments, other modes may be included such as allowing the user to be a yipper, a clerk, a planted mole trying to bid up the auction, or the like.

In such embodiments, the bidder mode could operate similar to the above-described embodiment. Additional features that may be incorporated include granting rewards or points to the user based on how well he or she performs in the auction game. For instance, each product being auctioned may have an underlying database that defines the value of the product, the market rate for the product, the usefulness of the product, the quality of the product, the condition of the product, etc. The data for the product may be totally fictitious or it may be based on data collected from one or multiple auctions for similar products or even the exact same product. The bidder may score points by bidding in a fashion that does not arbitrarily run the price of the product up, by winning an auction, by winning an auction at a price that is below the expected market value, etc. Similarly, the bidder may lose points by taking actions that escalate the bidding price of the product, losing the item to a competing bidder, winning the item at a value that is above the expected market value of the product etc.

Further, the bidder may qualify to enter the auctioneer mode by scoring a required number of points. In other embodiments, the auctioneer mode may simply be selectable. In the auctioneer mode, the mapping of the user interface may be modified. For instance, rather than entering bids via the user interface, the user interface is now used to solicit bids from the bidding audience. In one embodiment, the auctioneer interface may simply be akin to the GUITAR HERO or ROCK BAND interface in which various auctioning events that would be typical of an auctioneer are displayed on the screen in lieu of the colored notes. The various events would correspond to the keys on the guitar and the auctioneer player would be required to follow the actions by pressing the appropriate keys on the game interface. In some embodiments, the auction events may actually be a live feed from a real life auction, either in real time or in a play back mode. In another embodiment, the auctioneer player may have a set list of auction events that he or she can invoke at appropriate times. For instance the following example of a mapping could be utilized:

Red button—prod or prompt the most recently outbid bidder to get back on board

Blue button—accept a new high bid

Green button—ask for a new bid at a next increment

Yellow button—ask for a new bid at a particular value

Whammy bar—use this to select a particular value that is higher or lower than the standard next increment or using a combination of the whammy bar with other button presses to make motivational statements to control the auction and generate interest.

In this embodiment, the auctioneer player then has the freedom to run the auction as he or she sees fit to try to bring in top dollar for the product. The auctioneer may receive points by extracting greater value for a product than the expected or known value for the product. In addition, the auctioneer may be rewarded points by the style being applied and/or by adjusting the applied style based on audience or bidder activity feedback presented to the auctioneer player. For instance, if the auctioneer player spends too much time seeking a bid at a particular value before either decreasing the next bid level or rewarding the bid to a particular bidder, the auctioneer player may lose points. As another example, the user interface may show avatars representing the various audience bidders. If the avatars start fidgeting or walking away, the auctioneer player should conclude that the audience is bored or not interested and, as such, the auctioneer may lose points unless he or she does something to generate interest and draw the attention of the bidding audience or draw more participants into the auction event.

In some embodiments, the auctioneer may even be able to pre-program certain phrases and statements into the system and then call them up during the auction event. Thus, the auctioneer player can then observe how the bidding audience reacts and then change his style or technique accordingly to gain more points.

Thus, in the various embodiments, the integration of the online auctioning environment and the desired user interface can occur at various levels. One embodiment has been described as a flat integration in which simply some of the characters and aspects of the desired user interface have been mapped to standard actions or activities in the online auctioning environment. Another embodiment has been described as fully implementing the desired user environment, such as a gaming environment, modified in such a manner to have the game include an auction style underlying game.

Other embodiments may take on a variety of levels of integration. For instance, a live, online auctioning environment may be integrated with a desired user interface at more than a flat level. As an example of such an embodiment, integration with the user interface of SUPER MARIO GALAXY (SMG) is presented.

SMG is set in outer space, where Mario travels from galaxy to galaxy in order to collect Power Stars, which are earned by completing quests or defeating enemies. Each galaxy contains a number of planets and other space matter for the player to explore. The game uses a new physics system that allows for a unique feature: each celestial object has its own gravitational force, allowing the player to completely circumnavigate rounded or irregular planetoids, walking sideways or upside down, a feature seen previously in Super Mario World 2: Yoshi's Island. The player is usually able to jump from one independent object and then fall towards another one close by. Though the main gameplay and physics are in 3D, there are several points in the game in which the player's movements are restricted to a 2-dimensional axis, reminiscent of 2D Mario games.

The game's main hub is the Comet Observatory, which contains six themed domes that provide access to the forty-two galaxies available in the game. When the player first begins the game, the player only has access to a limited number of galaxies. However, as more Power Stars are collected, more galaxies become available for the player to access. Some galaxies are accessed through special means; for example, the star-shaped creatures called “Hungry Lumas” will transform into new galaxies once they are fed enough Star Bits (Small, collectible objects that serve as weapons and currency in the game). The Hungry Lumas may also appear within the galaxy, and when they are fed enough Star Bits, they will transform into other planetary bodies which will contain some form of puzzle or challenge which will reward Mario with a Power Star when the challenge is complete. When 120 Power Stars are collected, the player has the ability to play through again as Mario's brother Luigi. Gameplay is slightly different while playing as Luigi, as some obstacles can be harder or easier to overcome. Once 120 Power Stars are collected with both characters, the player is rewarded two additional challenges as well as two commemorative pictures that are sent to the player.

There are five “Prankster Comets” that appear periodically (Speedy, Daredevil, Cosmic, Fast Foe, and Purple). When one of them comes into orbit with a galaxy, a special challenge is initiated that leads to a Power Star. The Speedy Comet challenges the player to replay an episode (usually a slightly more difficult version) within a varying time limit. The Daredevil Comet has the player replay a section of a level while shrinking Mario's maximum health to one unit, meaning that the player must complete the objective without being damaged even once. The Cosmic Comet pits the player in a race against a doppelganger of Mario (or Luigi) to a Power Star. The Fast Foe Comet makes a galaxy's enemies swifter than usual and thus harder to avoid. The Purple Comet, accessible only after completing the story half of the game, allots 100 purple coins (or 150, though only 100 are needed) across an area of the 15 six-star galaxies for the player to collect, sometimes within a time limit.

The player's character is controlled via the playing device Remote and Nunchuk. While most of Mario's abilities are directly from Super Mario 64, such as the long jump, wall jumps, and a variety of somersaults, Mario is given new moves that take advantage of the playing device Remote's pointer and motion sensing. The most basic control scheme is the Star Pointer, which appears on-screen for the entire game and both marks the position of and is controlled by the Remote. First and foremost, the Star Pointer is used to pick up special konpeito-shaped objects called “Star Bits”, which are then shot to stun enemies, manipulate obstacles, or feed Hungry Lumas. Secondly, the pointer can latch onto small blue objects called “Pull Stars” that gradually pull Mario through space. Lastly, if the player becomes encased in a floating bubble, the Star Pointer is used to blow air at it in order to influence the direction and speed it moves. Luigi controls identically to Mario, but he has both better jumping abilities and less traction, making some areas either less or more challenging when playing through the game the second time.

The player gains a new ability early in the game, known as the “Spin” technique, which has previously appeared in varying forms since Super Mario Bros. 3. In Super Mario Galaxy the Spin is primarily used for melee attacks, as it can stun enemies and shatter objects, and is used to trigger special propellers called “Sling Stars” or “Launch Stars” that launch Mario across large distances through space. The Spin is also used for climbing vines, ice-skating, unscrewing bolts, and for activating several power-ups. Other Remote functions are available for smaller quests, such as surfing aboard a manta ray or balancing atop a large ball and rolling it through an obstacle course.

Super Mario Galaxy features the most power-ups and transformations of all 3D Mario games to date. Nine power-ups supply Mario with a special costume that grants him new abilities. For example, special Mushrooms bestow the player with a Bee, Boo, or Spring Suit. The Bee Suit allows the player to hover through the air, climb special walls, and walk on clouds; the Boo Suit allows the player to float through the air, as well as become transparent and move through obstacles; and the Spring Suit allows the player to jump to high areas that would otherwise be inaccessible. The Fire Flower, which allows the player to throw fireballs, also makes its first 3D appearance alongside its polar opposite, the Ice Flower, which creates tiles of ice to cover any liquid surface Mario walks on. The Rainbow Star grants Mario invincibility, allowing him to destroy multiple enemies. He can also jump higher and run faster. The Red Star, which is only accessible after completing a certain mission, allows Mario to fly.

Mario's health consists of a three-piece power meter, which can be depleted from contact with enemies and hazards. When swimming, Mario has an air supply meter, which will lead to quick depletion of his main power meter if it runs out. Mario's health can be restored via collecting Coins, while his air supply can be restored by touching bubbles or reaching the surface. When the power meter becomes empty, the player loses a life and must return to a predetermined checkpoint. The power meter can be temporarily expanded to six units through the use of a Life Mushroom, with the maximum health returning to three units if the overall health falls to three units from enemy or hazard contact or if Mario suffers instant death. Instant death can occur by being swallowed by quicksand or dark matter; falling into bottomless pits, which either consist of black holes or leaving a planet's gravitational pull and falling into space; getting crushed between objects; losing a race against a non-player character; or other special challenges. The player can obtain extra lives by collecting 1-Up Mushrooms, 50 Star Bits, or 50 Coins while on a single level. Different colored Hungry Lumas can also exchange Star Bits for 1-Up Mushrooms and Life Mushrooms in certain galaxies.

Super Mario Galaxy has a co-operative two-player option called “Co-Star Mode”, in which one player controls Mario and a Star Pointer while the other controls a second Star Pointer on-screen to gather Star Bits and shoot them at enemies (The first player's Star Pointer is blue, while the second player's Star Pointer is yellow). While the first player can normally do this except during certain events, the second player can shoot star bits without restriction. Additionally, the second player can make Mario jump, or the height of Mario's jump can be increased if the first and second player press the A button at the same moment. The second player's pointer star can also be aimed at some enemies to stop them by holding the A button, which prevents them from moving. The second player does not need the Nunchuk in order to play.

Shortly after Mario is invited to the centennial Star Festival by Princess Peach to celebrate the comet that passes overhead, Bowser invades the Mushroom Kingdom with a surprise attack in a fleet of airships. Summoning a giant flying saucer, he rips Princess Peach's entire castle from its foundations and lifts it into outer space. After an unsuccessful rescue attempt, Mario is catapulted across the cosmos and awakens on a small planet. On the planet he meets a mysterious woman called Rosalina and her companion stars, the Lumas. Rosalina is a watcher of the stars, who uses her mobile Observatory to travel across the universe. However, the Power Stars that act as the Observatory's power source have all been stolen by Bowser, rendering it immobile. Bestowed with the power to travel through space, Mario sets off on an intergalactic adventure across the universe to reclaim the Power Stars and restore power to Rosalina's observatory, with some help from Luigi and the Toad Brigade, a small group of Toads that escaped from Bowser when he stole Peach's castle.

Upon collecting enough Power Stars, Rosalina's Observatory has enough power to transform into a comet and fly to the center of the universe, where Peach is held captive. Confronting Bowser, Mario learns that Bowser's plan is to rule the entire universe with Peach at his side, using a newly constructed sun of his own via the power of the Grand Stars. Mario manages to defeat Bowser and free Peach, but Bowser's sun collapses onto itself, becoming a super massive black hole that consumes the nearby galaxies. All of Rosalina's Lumas jump into the black hole to destroy it, but sacrifice themselves in the process. The galaxies sucked into the black hole collapse into a singularity and explode in a Big Bang. Rosalina appears to Mario as a giantess, stating that stars never die, but are later reborn as new stars. Mario awakens in the restored Mushroom Kingdom alongside Peach and Bowser, celebrating the new galaxy that has emerged in the skies.

A variety of mappings may be implemented in a variety of integration levels with a gaming interface such as SMG. For instance, Mario may represent the bidding user. The various enemies and obstacles in SMG may represent higher bids that must be overcome or defeated for the bidder to enter a new bid to outbid the current high bidder. In fact, each obstacle in the SMG environment may represent a bidder that must be out bid. Winning a bid may be akin to rescuing Princess Peachy. In addition, in an auction environment that may include multiple, simultaneous auctions, the various lanes or auction events may be represented or mapped to the six themed domes that provide access to the forty-two galaxies available in the game. When the bidder wants to participate in a different auctioning event, he or she must traverse to the next galaxy. In addition or in lieu of, the bidder may only be qualified to gain access to additional galaxies by increasing a line of credit or by providing certification details to establish credit worthiness. Each auction may be represented by a specific level in the SMG game and only by successfully completing the level does the bidder successfully out bid other audience participants.

Alternatively, an exemplary integration level may include auctions embedded within the game such that an online user of the game may navigate his avatar, i.e. Mario for example, into the auction event and employ the mapped functions of the game controller to bid on, or outright purchase, items that may be subsequently shipped to the user's address. Such integration may operate in a way that users collect points over time through game play, store those points in an online account, and then enter the auction event during game play to purchase via the points a “Mario T-shirt” or whatever item, branded or otherwise, is so desired. Upon entering the embedded auction environment within the game, items may be for sale at a set price or up for auction as remote online users have an added incentive to spend countless hours playing the game over a set period of time in an effort to gain enough points to outbid other online users for a commemorative item up for sale in a live auction, for example. Alternatively, in lieu of game points, the item in the embedded auctions could be sold for real currency and paid for through an online account, such as PAYPAL, associated with the user.

Also, to entice online users to navigate into the embedded auction environment and purchase or bid for items, advertisements and other marketing strategies could be employed all through the game environment. As an example, as Mario leaps from one point to another in the SMG game environment, the user could be exposed to advertisements in the background of the game environment. As another non-limiting example, characters in the SMG game environment may approach a user's Mario avatar and “suggest” that he enter the auction environment and purchase a highly sought after commemorative Mario jacket, for example.

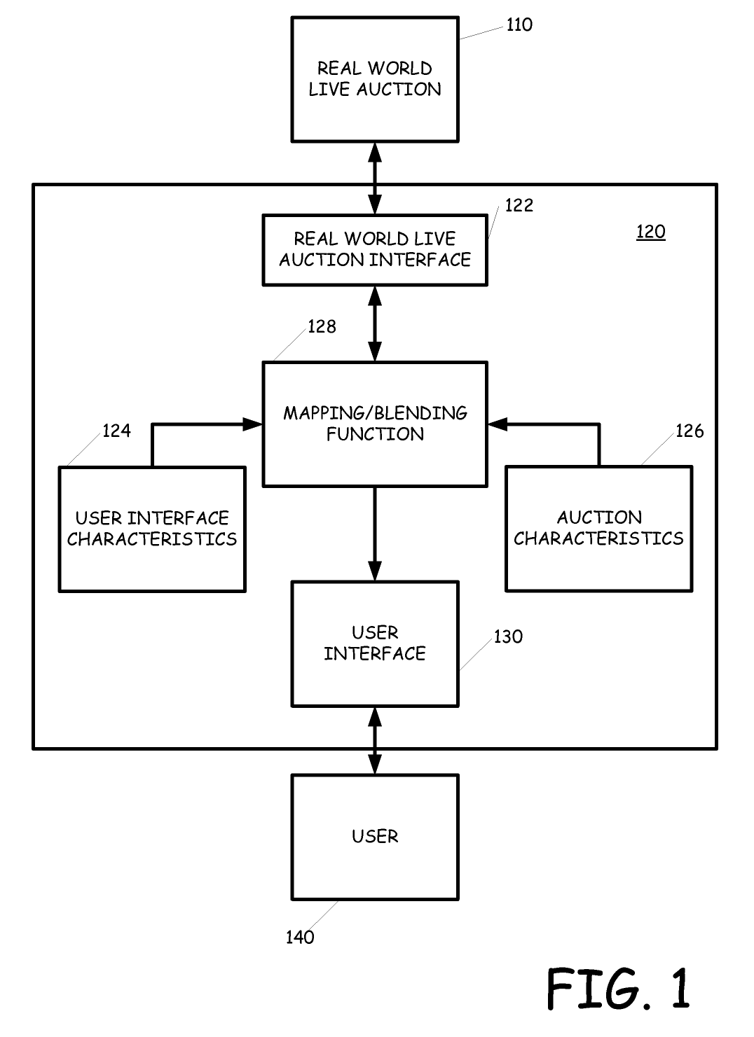

FIG. 1 is a block diagram illustrating functions that may be incorporated into various embodiments. A real world live auction 110 is shown as interfacing to a computing platform 120 implementing an embodiment of the integrated online auctioning system and a desired user interface. The auction system 110 interfaces with the computing platform 120 through the real world live auction interface 122.

A block is shown as housing the user interface characteristics 124 and another block is shown as housing the auction characteristics 126. These blocks may simply be databases or memory storage devices of the various characters, aspects, features, actions, etc. of the respective elements. The databases may be populated by the user or may be designed into the embodiment of the invention. A mapping/blending function 128 operates to correlate the elements in the user interface characteristics 124 and the auction characteristics 126 blocks to create a blended interface for the integrated system. The blended interface is the presented to the user 140 through the user interface 130. It will be appreciated that although the illustrated embodiment is shown as only including user interface characteristics for one desired user interface, embodiments may actually include multiple user interfaces and allow the user to select between which interface is activated. Further, in some embodiments the interfaces may be blended together to create a unique interface based on two or more desired user interfaces.

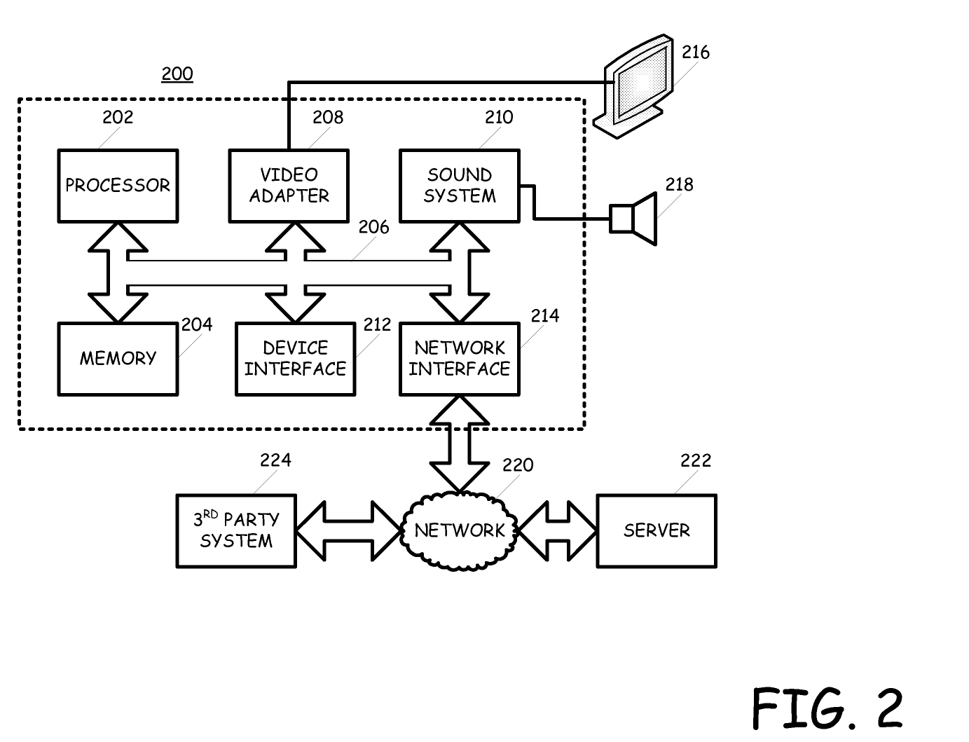

FIG. 2 is a general block diagram illustrating a hardware/system environment suitable for various embodiments of the present invention. A general computing platform 200 is shown as including a processor 202 that interfaces with a memory device 204 over a bus or similar interface 206. The processor 202 can be a variety of processor types including microprocessors, micro-controllers, programmable arrays, custom IC's etc. and may also include single or multiple processors with or without accelerators or the like. The memory element 204 may include a variety of structures, including but not limited to RAM, ROM, magnetic media, optical media, bubble memory, FLASH memory, EPROM, EEPROM, etc. The processor 202 also interfaces to a variety of elements including a video adapter 208, sound system 210, device interface 212 and network interface 214. The video adapter 208 is used to drive a display, monitor or dumb terminal 216. The sound system 210 interfaces to and drives a speaker or speaker system 218. The device interface 212 may interface to a variety of devices (not shown) such as a keyboard, a mouse, a pin pad, and audio activate device, a PS3 or other game controller, as well as a variety of the many other available input and output devices. The network interface 214 is used to interface the computing platform 200 to other devices through a network 220. The network may be a local network, a wide area network, a global network such as the Internet, or any of a variety of other configurations include hybrids, etc. The network interface may be a wired interface or a wireless interface. The computing platform 200 is shown as interfacing to a server 222 and a third party system 224 through the network 220.

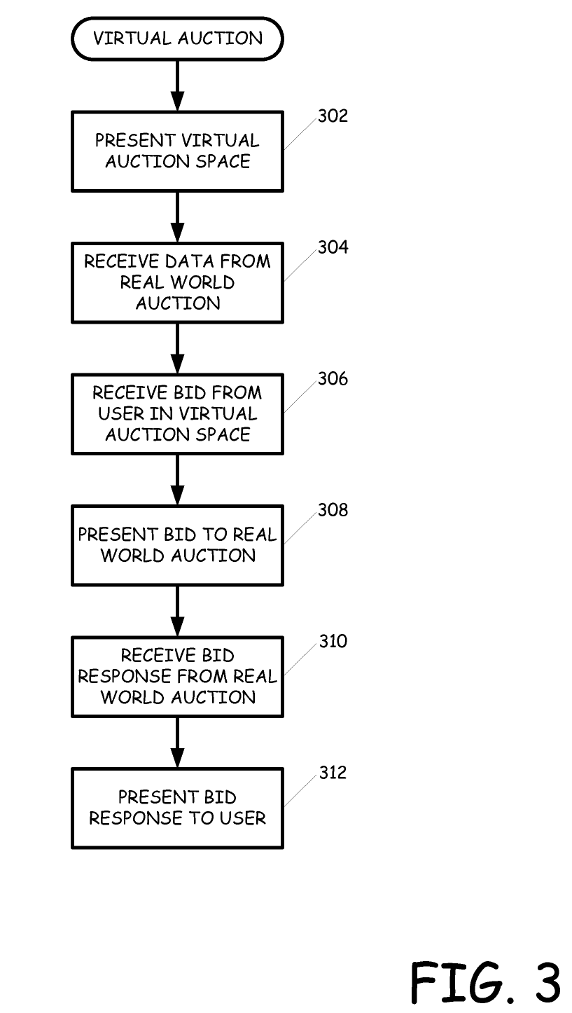

FIG. 3 is a flow diagram illustrating the steps in an exemplary embodiment of a virtual auction that is integrated with a real, live auction and embedded in a game space. Initially, a virtual auction space is presented within a game environment 302. A user can interact with the virtual auction space by virtually walking into the auction area or by other techniques. When a real world auction environment is being presented, data from the real world auction is received 304 and then presented within the virtual auction space. A user that is interfacing to the virtual auction space can then place a bid on an item, via mapped functions on a game controller, that is presently being auctioned 306. The received bid can then be presented to the real world auction as an entered bid for the item 308. The bid may be accepted, rejected or may result in being the winning bid. The response to the bid is then received from the real world auction environment 310 and is then presented to the bidder, as well as others participating in the real or virtual auctioning event 312.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A computing platform for integrating an online auctioning system with the user interface associated with a desired application, the computer platform comprising:
a processor;
a memory device communicatively coupled to the processor and containing definitions for the user interface associated with the desired application and characteristics of the online auctioning system;
a third party interface to a real-world live auction for receiving auction data;
a user interface;
a blending component residing on a memory device and including instructions that, when executed by the processor, are operative to:
identify elements associated with the user interface that is associated with the desired application;
identify characteristics of the online auctioning system;
map the elements of the user interface to the characteristics of the online auctioning system;
generate an integrated user interface and present it to a user; and
receive actions from the user and the online auctioning system and control the user interface based on the received actions.

2. The computing platform of claim 1, wherein the characteristics of the online auctioning system that are mapped to elements of the integrated user interface are characteristics associated with a bidder.

3. The computing platform of claim 1, wherein the characteristics of the online auctioning system that are mapped to elements of the integrated user interface are characteristics associated with an auctioneer.

4. The computing platform of claim 1, further comprising a step for quantifying received user actions.

5. The computing platform of claim 4, wherein the quantification comprises the assignment of points.

6. The computing platform of claim 4, wherein the quantification comprises awarding a voucher.

7. The computing platform of claim 1, further comprising a virtual auction space component residing on a memory device and including instructions that when executed by the processor, are operative to:
receive the auction data from the third party interface;
create a visual environment embedded within the desired application for presentment of the auctioning data to the user interface;
receive a bid from the user interface for an item being auctioned as defined in the auction data;
present the bid to the real world auction through the third party interface;
receive data from the third party interface indicating that the bid from the user interface has been accepted as a winning bid for the item being auctioned; and
finalize a transaction to attribute the item to a user associated with the bid.

8. The computing platform of claim 7, wherein the step of creating a visual environment embedded within the desired application for presentment of the auctioning data to the user interface further comprises creating at least one avatar within the visual environment.

9. The computing platform of claim 8, wherein the at least one avatar represents a user other than said user.

10. The computing platform of claim 7, wherein the step of finalizing a transaction to attribute the item to a user associated with the bid further comprises a monetary transaction.

11. The computing platform of claim 7, wherein the step of finalizing a transaction to attribute the item to a user associated with the bid further comprises the redemption of a voucher.

12. The computing platform of claim 11, wherein the voucher was obtained by the user through previous activity within the virtual world environment.

13. The computing platform of claim 7, wherein the step of finalizing a transaction to attribute the item to a user associated with the bid further comprises presenting said user with a real-world item.

14. The computing platform of claim 7, wherein the step of creating a visual environment for presentment of the auctioning data to the user interface further comprises exposing the user to at least one advertisement.

15. The computing platform of claim 14, wherein said at least one advertisement is delivered via a character within said desired application.

16. A method for providing an auction element within a desired application wherein the auction element is integrated with a real-world auction, the method comprising the steps of:
identifying elements associated with the user interface that is associated with the desired application;
identifying characteristics of the online auctioning system;
mapping the elements of the user interface to the characteristics of the online auctioning system;
generating an integrated user interface and presenting it to a user;
receiving auction data from a third party interface to said real-world auction;
creating a visual environment for presentment of the auction data to an integrated user interface to said desired application;
receiving actions from the user and the online auctioning system and controlling the integrated user interface based on the received actions;
receiving data from the third party interface indicating that the received actions from the integrated user interface have been accepted as a winning bid for an item being auctioned; and
finalizing a transaction to attribute the item to a user associated with the winning bid.
